(19) United States
(12) Patent Application Publication
(10) Pub. No.: US 2024/0073721 A1
(43) Pub. Date: Feb. 29, 2024

(54) MEASUREMENT COMPRESSION FOR MULTIPLE REFERENCE SIGNALS

(71) Applicant: QUALCOMM Incorporated, San Diego, CA (US)

(72) Inventors: Hua WANG, Basking Ridge, NJ (US); June NAMGOONG, San Diego, CA (US); Tianyang BAI, Somerville, NJ (US); Tao LUO, San Diego, CA (US); Junyi LI, Fairless Hills, PA (US)

(21) Appl. No.: 18/358,732

(22) Filed: Jul. 25, 2023

Related U.S. Application Data
(60) Provisional application No. 63/374,206, filed on Aug. 31, 2022.

(51) Int. Cl. H04W 24/08; H04W 24/10

(52) U.S. Cl. CPC H04W 24/08; H04W 24/10

(57) ABSTRACT

Various aspects of the present disclosure generally relate to wireless communication. In some aspects, a user equipment (UE) may receive multiple reference signals (RSs). The UE may measure the multiple RSs to generate measurements for the multiple RSs. The UE may encode the measurements using a machine learning model to generate codewords representing a quantized version of the measurements. The UE may transmit the codewords. Numerous other aspects are described.

### CROSS-REFERENCE TO RELATED APPLICATION

This patent application claims priority to U.S. Provisional Patent Application No. 63/374,206, filed on Aug. 31, 2022, entitled “MEASUREMENT COMPRESSION FOR MULTIPLE REFERENCE SIGNALS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses for compressing measurements for multiple reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving multiple reference signals (RSs). The method may include measuring the multiple RSs to generate measurements for the multiple RSs. The method may include encoding the measurements using a machine learning (ML) model to generate codewords representing a quantized version of the measurements. The method may include transmitting the codewords.

Some aspects described herein relate to a method of wireless communication performed by an apparatus of a network entity. The method may include transmitting a reporting configuration associated with using ML for quantizing measurements of multiple RSs. The method may include transmitting multiple RSs. The method may include receiving codewords that represent a quantized version of measurements of the multiple RSs. The method may include decoding the codewords to obtain the measurements of the multiple RSs.

Some aspects described herein relate to an apparatus of a UE for wireless communication. The apparatus of a UE may include one or memories and one or more processors coupled to the one or more memories. The one or more processors may be individually or collectively configured to cause the UE to receive multiple RSs. The one or more processors may be individually or collectively configured to cause the UE to measure the multiple RSs to generate measurements for the multiple RSs. The one or more processors may be individually or collectively configured to cause the UE to encode the measurements using an ML model to generate codewords representing a quantized version of the measurements. The one or more processors may be individually or collectively configured to cause the UE to transmit the codewords.

Some aspects described herein relate to an apparatus of a network entity for wireless communication. The apparatus of a network entity may include one or memories and one or more processors coupled to the one or memories. The one or more processors may be individually or collectively configured to cause the network entity to transmit a reporting configuration associated with using ML for quantizing measurements of multiple RSs. The one or more processors may be individually or collectively configured to cause the network entity to transmit multiple RSs. The one or more processors may be individually or collectively configured to cause the network entity to receive codewords that represent a quantized version of measurements of the multiple RSs. The one or more processors may be individually or collectively configured to cause the network entity to decode the codewords to obtain the measurements of the multiple RSs.

Some aspects described herein relate to a non-transitory computer-readable medium that stores a set of instructions for wireless communication by a UE. The set of instructions, when executed by one or more processors of the UE, may cause the UE to receive multiple RSs. The set of instructions, when executed by one or more processors of the UE, may cause the UE to measure the multiple RSs to generate measurements for the multiple RSs. The set of instructions, when executed by one or more processors of the UE, may cause the UE to encode the measurements using an ML model to generate codewords representing a quantized version of the measurements. The set of instructions, when executed by one or more processors of the UE, may cause the UE to transmit the codewords.

Some aspects described herein relate to a non-transitory computer-readable medium that stores a set of instructions for wireless communication by a network entity. The set of instructions, when executed by one or more processors of the network entity, may cause the network entity to transmit a reporting configuration associated with using ML for quantizing measurements of multiple RSs. The set of instructions, when executed by one or more processors of the network entity, may cause the network entity to transmit multiple RSs. The set of instructions, when executed by one or more processors of the network entity, may cause the network entity to receive codewords that represent a quantized version of measurements of the multiple RSs. The set of instructions, when executed by one or more processors of the network entity, may cause the network entity to decode the codewords to obtain the measurements of the multiple RSs.

Some aspects described herein relate to an apparatus for wireless communication. The apparatus may include means for receiving multiple RSs. The apparatus may include means for measuring the multiple RSs to generate measurements for the multiple RSs. The apparatus may include means for encoding the measurements using an ML model to generate codewords representing a quantized version of the measurements. The apparatus may include means for transmitting the codewords.

Some aspects described herein relate to an apparatus for wireless communication. The apparatus may include means for transmitting a reporting configuration associated with using ML for quantizing measurements of multiple RSs. The apparatus may include means for transmitting multiple RSs. The apparatus may include means for receiving codewords that represent a quantized version of measurements of the multiple RSs. The apparatus may include means for decoding the codewords to obtain the measurements of the multiple RSs.

Aspects generally include a method, apparatus, system, computer program product, non-transitory computer-readable medium, UE, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating an example of measurement compression and decompression, in accordance with the present disclosure.

FIG. 6 is a diagram illustrating an example of training and using a machine learning (ML) model in connection with selecting ML models for compression or decompression, in accordance with the present disclosure.

FIG. 7 is a diagram illustrating an example associated with reference signal received power measurement compression, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

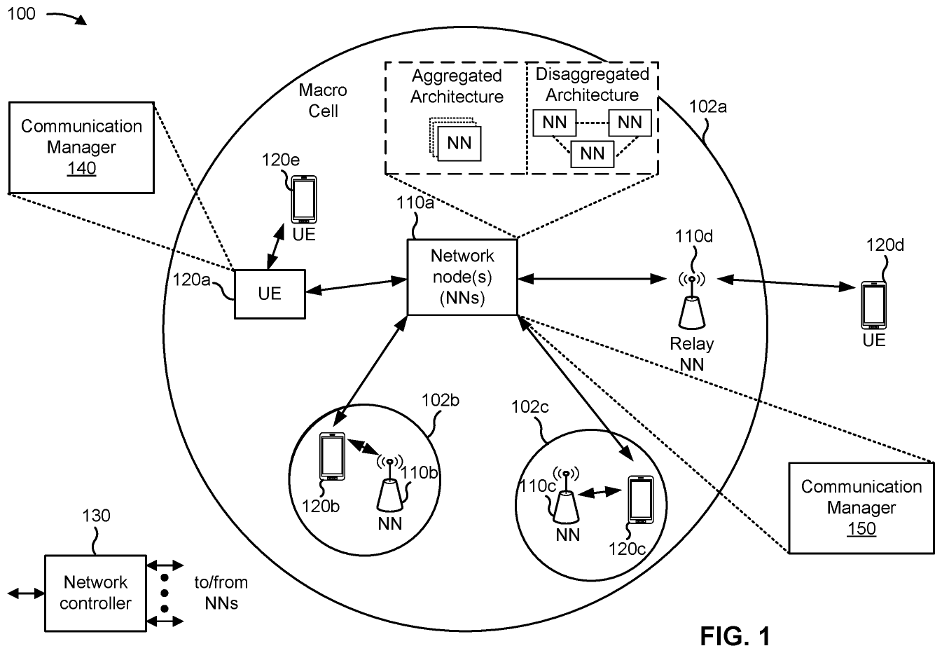

FIG. 1 is a diagram illustrating an example of a wireless network in accordance with the present disclosure. The wireless network 100 may be or may include elements of a 5G (e.g., NR) network or a 4G (e.g., Long Term Evolution (LTE)) network, among other examples. The wireless network 100 may include one or more network entities such as network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (e.g., in 4G), a gNB (e.g., in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move in accordance with the location of a network node 110 that is mobile (e.g., a mobile network node).

In some aspects, the term “base station,” “network entity”, or “network node” may refer to an aggregated base station, a disaggregated base station, an integrated access and backhaul (IAB) node, a relay node, or one or more components thereof. For example, in some aspects, “base station,” “network entity,” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station,” “network entity,” or “network node” may refer to one device configured to perform one or more functions, such as those described herein in connection with the network node 110. In some aspects, the term “base station,” “network entity,” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station,” “network entity,” or “network node” may refer to any one or more of those different devices. In some aspects, the term “base station,” “network entity,” or “network node” may refer to one or more virtual base stations or one or more virtual base station functions. For example, in some aspects, two or more base station functions may be instantiated on a single device. In some aspects, the term “base station,” “network entity,” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (e.g., a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (e.g., a remote device), or some other entity. Some UEs 120 may be considered Internet-of-Things (IoT) devices or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (e.g., one or more processors) and the memory components (e.g., a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (e.g., FR1, FR2, FR3, FR4, FR4-a, FR4-1, or FR5) may be modified, and techniques described herein are applicable to those modified frequency ranges.

In some aspects, a UE (e.g., a UE 120) may include a communication manager 140. As described in more detail elsewhere herein, the communication manager 140 may receive multiple reference signals (RSs). The communication manager 140 may measure the multiple RSs to generate measurements for the multiple RSs. The communication manager 140 may encode the measurements using a machine learning (ML) model to generate codewords representing a quantized version of the measurements and transmit the codewords. Additionally, or alternatively, the communication manager 140 may perform one or more other operations described herein.

In some aspects, a network entity (e.g., network node 110) may include a communication manager 150. As described in more detail elsewhere herein, the communication manager 150 may transmit a reporting configuration associated with using ML for quantizing measurements of multiple RSs. The communication manager 150 may transmit multiple RSs. The communication manager 150 may receive codewords that represent a quantized version of measurements of the multiple RSs. The communication manager 140 may decode the codewords to obtain the measurements of the multiple RSs. Additionally, or alternatively, the communication manager 150 may perform one or more other operations described herein.

As indicated above, FIG. 1 is provided as an example. Other examples may differ from what is described with regard to FIG. 1.

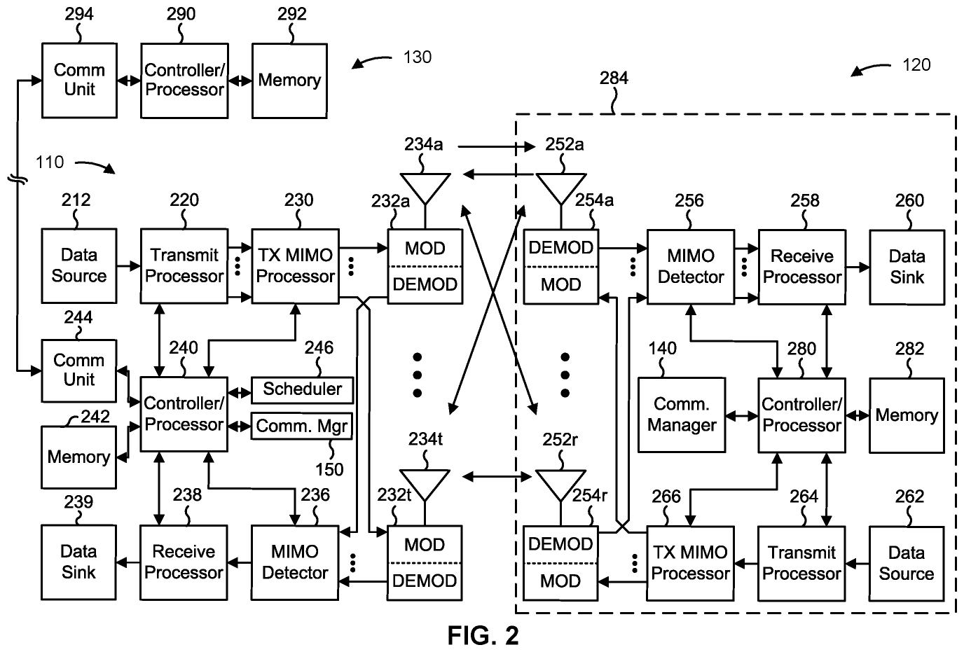

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (e.g., for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (e.g., the controller/processor 280) and the memory 282 to perform aspects of any of the methods described herein.

At the network node 110, the uplink signals from UE 120 or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (e.g., the controller/processor 240) and the memory 242 to perform aspects of any of the methods described herein.

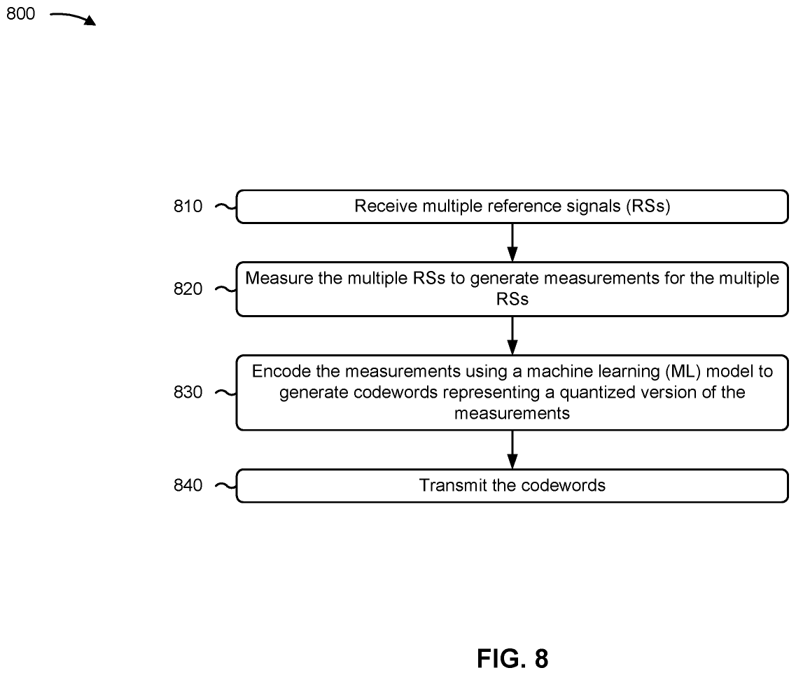

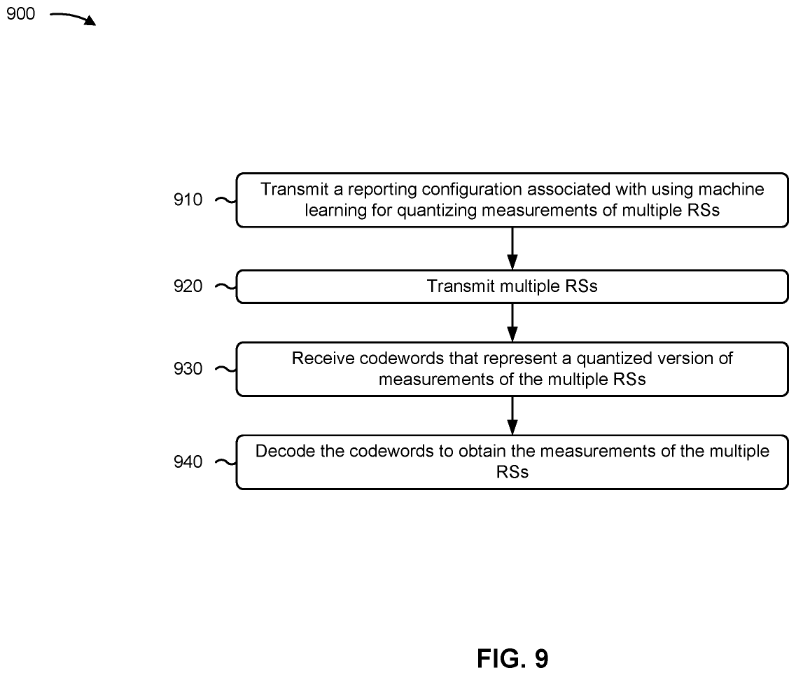

A controller/processor of a network entity (e.g., controller/processor 240 of the network node 110), the controller/processor 280 of the UE 120, or any other component(s) of FIG. 2 may perform one or more techniques associated with compressing measurements for multiple RSs, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (e.g., code or program code) for wireless communication. For example, the one or more instructions, when executed (e.g., directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, or other processes as described herein. In some examples, executing instructions may include running the instructions, converting the instructions, compiling the instructions, or interpreting the instructions, among other examples.

In some aspects, a UE (e.g., a UE 120) includes means for receiving multiple RSs; means for measuring the multiple RSs to generate measurements for the multiple RSs; means for encoding the measurements using an ML model to generate codewords representing a quantized version of the measurements; and/or means for transmitting the codewords. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., network node 110) includes means for transmitting a reporting configuration associated with using ML for quantizing measurements of multiple RSs; means for transmitting multiple RSs; means for receiving codewords that represent a quantized version of measurements of the multiple RSs; and/or means for decoding the codewords to obtain the measurements of the multiple RSs. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

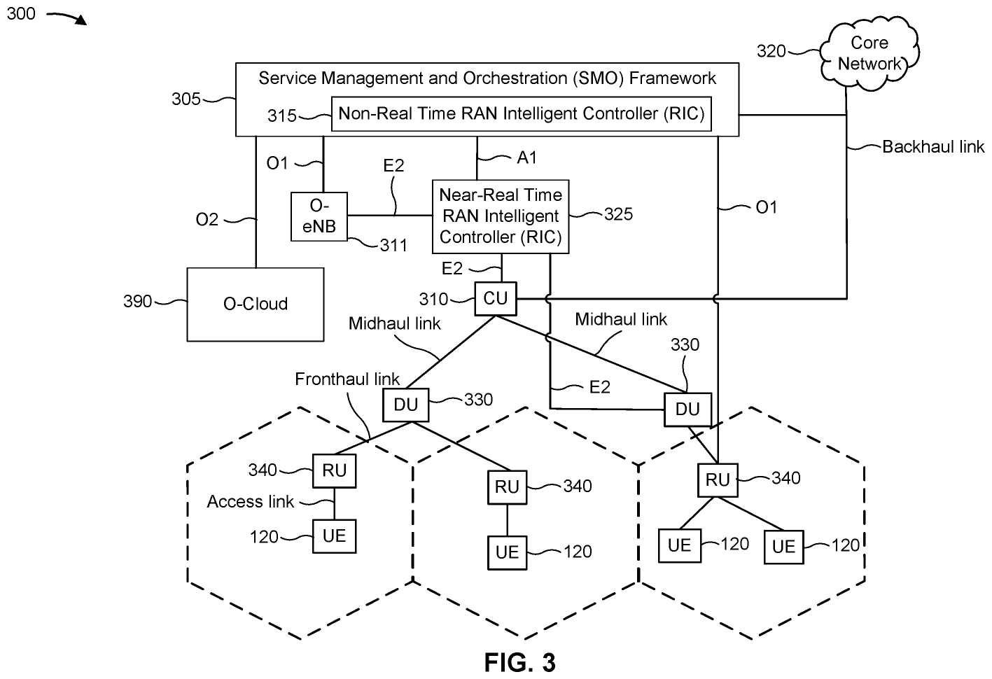

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit—User Plane (CU-UP) functionality), control plane functionality (e.g., Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

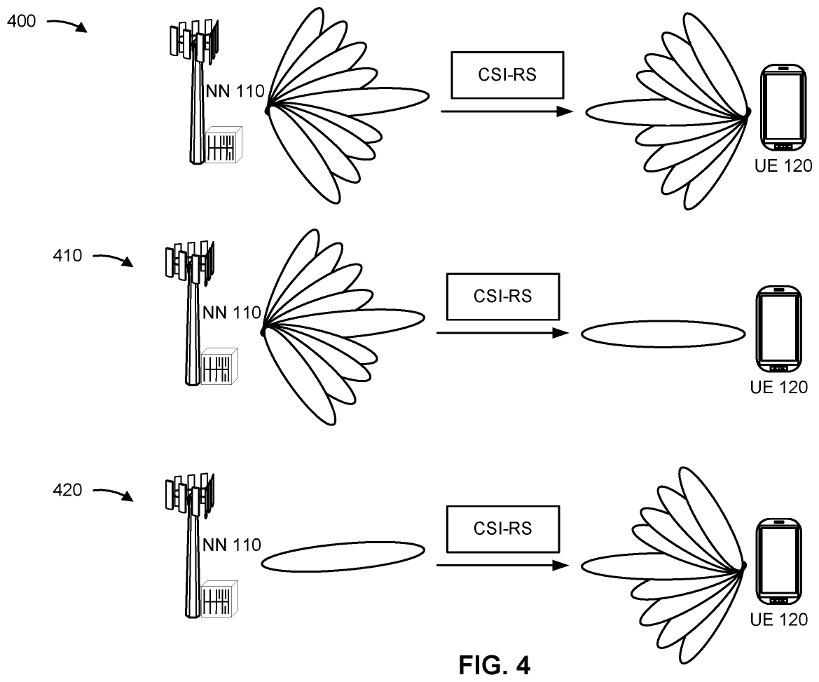

FIG. 4 is a diagram illustrating examples of channel state information (CSI) reference signal (CSI-RS) beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network entity or TRP, between a mobile termination node and a control node, between an IAB child node and an IAB parent node, or between a scheduled node and a scheduling node). In some aspects, the UE 120 and the network entity may be in a connected state (e.g., an RRC connected state).

As shown in FIG. 4, example 400 may include a network entity (e.g., one or more network node devices such as an RU, a DU, or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, or a beam search procedure. As shown in FIG. 4 and example 400, CSI-RSs may be configured to be transmitted from the network entity to the UE 120. The CSI-RSs may be configured to be periodic (e.g., using RRC signaling), semi-persistent (e.g., using media access control (MAC) control element (MAC-CE) signaling), or aperiodic (e.g., using downlink control information (DCI)).

The first beam management procedure may include the network entity performing beam sweeping over multiple transmit (Tx) beams. The network entity may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network entity has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network entity, the UE 120 may perform beam sweeping through the receive beams of the UE 120. As a result, the first beam management procedure may enable the UE 120 to measure a CSI-RS on different transmit beams using different receive beams to support selection of network entity transmit beams/UE 120 receive beam(s) beam pair(s). The UE 120 may report the measurements to the network entity to enable the network entity to select one or more beam pair(s) for communication between the network entity and the UE 120. While example 400 has been described in connection with CSI-RSs, the first beam management process may also use synchronization signal blocks (SSBs) for beam management in a similar manner as described above.

As shown in FIG. 4, example 410 may include a network entity and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, or a transmit beam refinement procedure. As shown in FIG. 4 and example 410, CSI-RSs may be configured to be transmitted from the network entity to the UE 120. The CSI-RSs may be configured to be aperiodic (e.g., using DCI). The second beam management procedure may include the network entity performing beam sweeping over one or more transmit beams. The one or more transmit beams may be a subset of all transmit beams associated with the network entity (e.g., determined based at least in part on measurements reported by the UE 120 in connection with the first beam management procedure). The network entity may transmit a CSI-RS using each transmit beam of the one or more transmit beams for beam management. The UE 120 may measure each CSI-RS using a single (e.g., the same) receive beam (e.g., determined based at least in part on measurements performed in connection with the first beam management procedure). The second beam management procedure may enable the network entity to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, or a receive beam refinement procedure. As shown in FIG. 4 and example 420, one or more CSI-RSs may be configured to be transmitted from the network entity to the UE 120. The CSI-RSs may be configured to be aperiodic (e.g., using DCI). The third beam management process may include the network entity transmitting the one or more CSI-RS s using a single transmit beam (e.g., determined based at least in part on measurements reported by the UE 120 in connection with the first beam management procedure or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure or the second beam management procedure). The third beam management procedure may enable the network entity or the UE 120 to select a best receive beam based at least in part on reported measurements received from the UE 120 (e.g., of the CSI-RS of the transmit beam using the one or more receive beams). A beam index may be encoded using 6 or 7 bits.

In some aspects, measurements for beam management may include Layer 1 (L1) RSRP measurements, such as L1 RSRP measurements for SSBs (L1 SSB-RSRP) and for CSI-RSs (L1 CSI-RSRP). L1 SSB-RSRP and L1 CSI-RSRP reporting ranges may be −140 decibel milliwatts (dBm) to −40 dBm with 1 decibel (dB) resolution. An L1 RSRP measurement, such as the strongest RSRP, may have a 7 bit payload to represent 128 values. In some aspects, an L1 RSRP measurement may be a differential RSRP, which is a difference of the RSRP over a reference RSRP (e.g., the strongest RSRP). The reporting range of differential SSB-RSRP and CSI-RSRP for L1 reporting may be from 0 dBm to −30 dB with 2 dB resolution. A differential L1 measurement of an RSRP may be, for example, 4 bits. Other measurements may include signal-to-noise ratio (SNR) measurements, signal-to-interference-plus-noise ratio (SINR) measurements, RSSI, or other reference signal metrics.

In an example, an L1 RSRP report of 4 RSRP measurements out of 128 CSI-RSs may include 7×4 bits for a CSI-RS resource indicator (CRI) and 7+(4×3) bits for the RSRP measurement, for a total of 47 bits (28+19). With 40 to 50 bits, only 4 RSRP values can be reported. For some applications, more RSRP values may need to be reported. Furthermore, a 2 dB granularity for differential RSRP may not be sufficiently precise. For example, for beam prediction using ML, to predict the RSRP of 64 narrow CSI-RS beams from measured RSRP of SSB beams, 8 or 16 SSB RSRPs are expected to be reported, with a better resolution than 2 dB. If the 47 bits needed to report 4 RSRP measurements are multiplied to report even 8 or 16 RSRPs, the number of bits can be in the hundreds. That is, reporting for multiple RSs may consume significant signaling resources.

As indicated above, FIG. 4 is provided as an example. Other examples may differ from what is described with regard to FIG. 4.

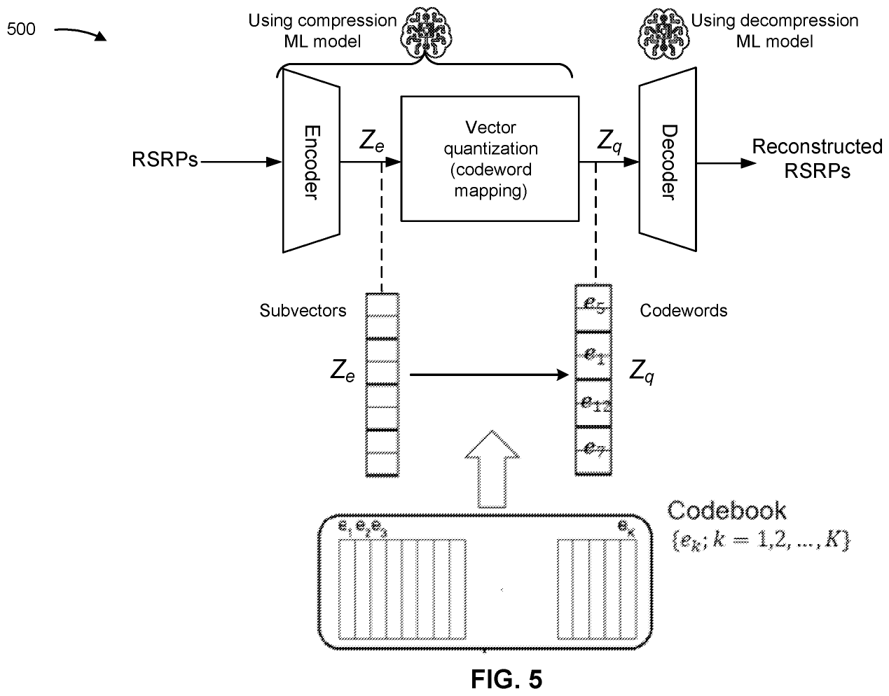

FIG. 5 is a diagram illustrating an example 500 of measurement compression and decompression, in accordance with the present disclosure.

In some examples, beam management may utilize ML, including AI. For example, the UE 120 may use an ML model to predict a beam to use for communication. An ML model may be, for example, a neural network model that is defined with a model architecture and a parameter set. The model architecture may be identified by a unique model identifier (ID) and use a parameter set. The parameter set may include weights for the neural network model and other configuration parameters. The parameter set may be location specific or configuration specific. Each ML model (identified by a model ID) may be associated with a neural network function (identified by a neural network function ID) that receives inputs and provides an output.

According to various aspects described herein, a UE may use ML to compress RSRP measurements for multiple RSs. Compression may involve quantization. For example, the UE may use an ML model to quantize measurements for multiple RSs into codewords that represent a quantized version of the measurements. In this way, over 160 RSs may be represented by about 40 bits of codewords, which currently is used for only 4 RSs. As a result, signaling resources are conserved and communications are improved. Latency may also be reduced as measurements for many RSs may be reported at once instead of over multiple reports.

In some aspects, the codewords may represent a quantized version of differential measurements, which are differences between measurements and a reference measurement (e.g., strongest measurement with greatest RSRP). The UE may transmit an indication of the differential measurements. The UE may also transmit an indication of the reference measurement, which may be 7 bits. That is, for about 40 to 50 bits, differential measurements may have more precision (more bits can be used) and allow for the simultaneous reporting of many RSs with a high rate of accuracy (e.g., at least 96%).

Example 500 illustrates an example architecture for using ML for reporting RSRP measurements. For example, an encoder and a vector quantization module at a UE may use an ML model (e.g., a compression ML model) to compress multiple RSRP measurements into codewords that represent a vector quantization of the multiple RSRP measurements. The multiple RSRP measurements may be input into an encoder that provides encoder output Zₑ. The encoder output Zₑ may be vector that is split into a set of sub-vectors. The sub-vectors may have quantized values (e.g., floating point, fixed point). The UE may map the quantized values to codewords based on a codebook that is shared between the UE and a network entity that receives the codewords. There may be k (e.g., 16) codewords in the codebook, with log₂k bits per sub-vector. Each sub-vector may be mapped to a closest codeword eₖ based on, for example, an L2 distance (e.g., involving a sum of squared values). Each vector may be represented by a different codebook. The resulting codewords (output Z_{q}) may represent a quantized version of multiple RSRP measurements. The UE may transmit an indication of the codewords to the network entity.

Because measurements for all of the RSs in a configured set of SSB or CSI-RSs can be represented by the codewords, the indication does not have to include additional bits for RS indices to link the RSRP measurements to the RSs. Instead, the RSRP measurements may follow a configured order or index list for RSs (e.g., ascending order of index). A default configured set may include all SSBs transmitted by the network entity and/or all CSI-RSs transmitted to the UE.

The network entity may use the codewords to obtain quantized values for the RSRP measurements. This may include using another ML model (e.g., a decompression ML model) at a decoder of the network entity to decompress the codewords received at the network entity and to reconstruct the RSRP measurements for the multiple RSs. In some aspects, if the codewords represent differential measurements, the network entity may add a value of the strongest measurement to the differential measurements. The UE may have used 0 (zero) as the quantized value for a differential measurement for the strongest measurement.

The ML models may be trained. In some aspects, the ML model for compression may be trained at the UE or the network entity using RS measurements of multiple RSs as inputs and quantized versions of multiple RSs as an output for a measurement report. Codewords may be trainable parameters learned through backpropagation in a multi-layer feed-forward neural network. The ML model for decompression may be trained at the network entity using compressed output as inputs and reconstructed RS measurements as the outputs. The encoder, the vector quantization, and the decoder may be jointly trained. ML models for compression and ML models for decompression may also be jointly trained. In some aspects, different versions of ML models may be trained for different types of models (e.g., raw RSRP, differential RSRP, for SSBs, for CSI-RSs) or for different quantities of RSs. In some aspects, ML models may be used to compress RSRP measurements of up to k SSBs or CSI-RSs of a configured set of SSBs or CSI-RSs.

The UE may transmit information about an ML model that is used or parameters that are used. The information may include a compression ML model architecture, a vector quantization architecture, an encoder architecture, and/or parameters of an ML model for compression. The network entity may select or consider an ML model (architecture, parameters) for decompression based at least in part on an ML model used for compression. In some aspects, the network entity may transmit, in a reporting configuration, information about an ML model that the UE is to use for compression. The information may also include a compression ML model architecture, a vector quantization architecture, an encoder architecture, and/or parameters of an ML model for compression.

In some aspects, the network entity may transmit, in the report configuration, multiple reporting options from which the UE is to select. A reporting option may include a compression ML model architecture, a vector quantization architecture, an encoder architecture, and/or parameters of an ML model for compression. The UE may select and use a reporting option. The UE may transmit an indication of which reporting option was selected.

The UE may select a reporting option based at least in part on an accuracy of a measurement report and/or a size of the measurement report. For example, if the UE is also provided with a decoder, the UE can execute the compression and decompression of RSRP measurements to check if the report of decompressed RSRP measurements (using the reporting option) for multiple RSs is more accurate than the report of uncompressed RSRP measurements (not using the reporting option). The reporting option may be selected if the reporting option is more accurate and not selected if the reporting option is not more accurate. If the payload size of the report that used the reporting option is smaller than a report that does not use the reporting option, the UE may select the reporting option. If the payload size of a report that used the reporting option is greater than a report that did not use the reporting option, the UE may not select the reporting option.

The UE may select a reporting option based at least in part on information or a rule in the reporting configuration. For example, the network entity may configure a report resource for reporting prediction results and define a timeline between the measuring and transmitting the report. Therefore, if the UE selects a reporting option that uses an ML model, the UE may be expected to complete the compression and reporting within a given timeline.

In some aspects, the UE may transmit an indication of a UE capability for using a reporting option with an ML model. The UE capability may indicate whether the UE is capable of supporting the use of ML models for compression. The UE capability may also indicate which compression ML model architecture, vector quantization architecture, encoder architecture, and/or parameters are supported.

As indicated above, FIG. 5 is provided as an example. Other examples may differ from what is described with regard to FIG. 5.

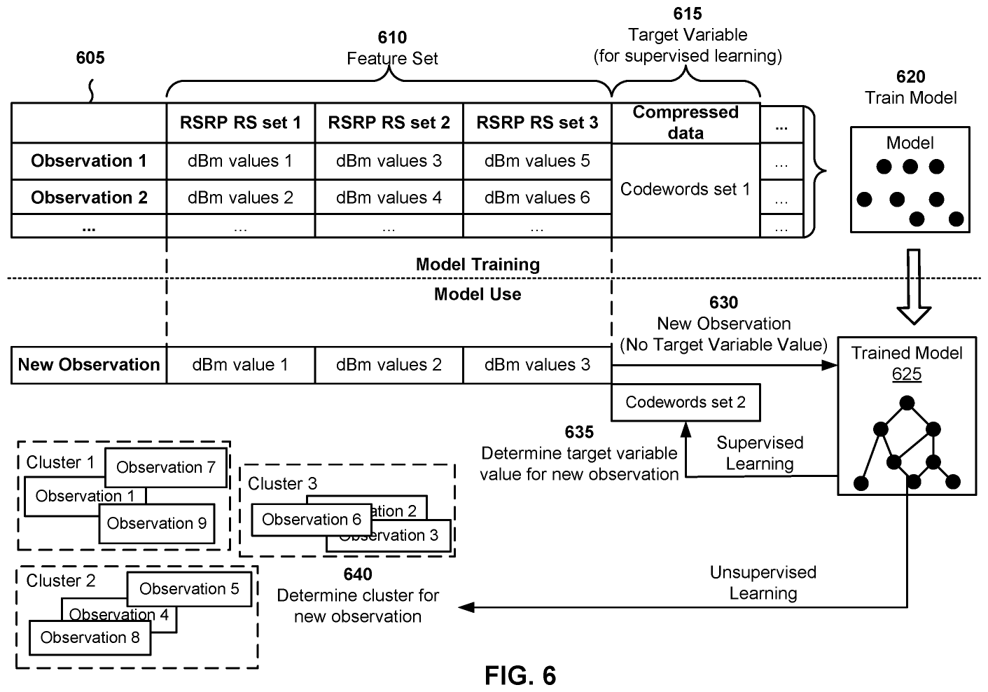

FIG. 6 is a diagram illustrating an example of training and using an ML model in connection with selecting ML models for compression or decompression, in accordance with the present disclosure. The ML model training and usage described herein may be performed using an ML system. The ML system may include or may be included in the UE 120, a network entity (e.g., network node 110), a computing device, a server, or a cloud computing environment.

In a first operation 605, an ML model may be trained using a set of observations. The set of observations may be obtained from training data (e.g., historical data), such as data gathered during one or more processes described herein. In some aspects, the ML system may receive the set of observations (e.g., as input) from past RS measurements, as described elsewhere herein.

In a second operation 610, the set of observations includes a feature set. The feature set may include a set of variables, and a variable may be referred to as a feature. A specific observation may include a set of variable values (or feature values) corresponding to the set of variables. In some aspects, the ML system may determine variables for a set of observations or variable values for a specific observation based on input received from UEs. For example, the ML system may identify a feature set (e.g., one or more features or feature values) by extracting the feature set from structured data, by performing natural language processing to extract the feature set from unstructured data, or by receiving input from an operator.

As an example, a feature set for a set of observations (e.g., at different times) may include a first feature of RSRP values (e.g., in decibel milliwatt (dBm)) for a first RS set 1, RSRP values for a second RS set 2, and RSRP values for a third RS set 3. As shown, for a first observation, the first feature may have first dBm values, the second feature may have second dBm values, the third feature may have third dBm values, and so forth. These features and feature values are provided as examples, and may differ in other examples. For example, the feature set may include one or more of the following features: RSRPs for RS sets, RSSIs for RS sets, SINRs for RS sets, or other type of measurements for RS sets of multiple RSs.

In a third operation 615, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels), may represent a set of information, or may represent a variable having a Boolean value. A target variable may be associated with a target variable value, and a target variable value may be specific to an observation. In example 600, the target variable is a first set of codewords 1. Codeword sets may be tested for accuracy when compared with reconstructed RSs.

The target variable may represent a value that an ML model is being trained to predict, and the feature set may represent the variables that are input to a trained ML model to predict a value for the target variable. The set of observations may include target variable values so that the ML model can be trained to recognize patterns in the feature set that lead to a target variable value. An ML model that is trained to predict a target variable value may be referred to as a supervised learning model.

In some implementations, the ML model may be trained on a set of observations that do not include a target variable. This may be referred to as an unsupervised learning model. In such examples, the ML model may learn patterns from the set of observations without labeling or supervision, and may provide output that indicates such patterns, such as by using clustering or association to identify related groups of items within the set of observations.

In a fourth operation 620, the ML system may train an ML model using the set of observations and using one or more ML algorithms, such as a regression algorithm, a decision tree algorithm, a neural network algorithm, a k-nearest neighbor algorithm, a support vector machine algorithm, among other examples. After training, the ML system may store the ML model as a trained ML model 625 to be used to analyze new observations.

In a fifth operation 630, the ML system may apply the trained ML model 625 to a new observation, such as by receiving a new observation and inputting the new observation to the trained ML model 625. The ML system may apply the trained ML model 625 to the new observation to generate an output (e.g., a result). The type of output may depend on the type of ML model or the type of ML task being performed. For example, the output may include a predicted value of a target variable, such as when supervised learning is employed. Additionally or alternatively, the output may include information that identifies a cluster to which the new observation belongs or information that indicates a degree of similarity between the new observation and one or more other observations, such as when unsupervised learning is employed.

As an example, the trained ML model 625 may predict a set of codewords for sub-vectors of RSRP measurements of a set of multiple RSs for the new observation, as shown in a sixth operation 635. Based on this prediction, the ML system may provide a first recommendation, may provide output for determination of a first recommendation, may perform a first automated action, or may cause a first automated action to be performed (e.g., by instructing another device to perform the automated action), among other examples. The first recommendation may include, for example, a particular set of codewords for RSRP measurements. The first automated action may include, for example, compressing RSRP measurements into a set of codewords.

As another example, if the ML system were to predict another set of codewords for the target variable of compressed data with a threshold accuracy, then the ML system may provide a second (e.g., different) recommendation (e.g., second set of codewords) or may perform or cause performance of a second (e.g., different) automated action (e.g., select a different set of codewords).

In some aspects, the trained ML model 625 may classify (e.g., cluster) the new observation in a cluster, as shown in a seventh operation 640. The observations within a cluster may have a threshold degree of similarity. As an example, if the ML system classifies the new observation in a first cluster (e.g., sets of codewords for RSRP measurements of RS sets), then the ML system may provide a first recommendation, such as the first recommendation described above. Additionally or alternatively, the ML system may perform a first automated action or may cause a first automated action to be performed (e.g., by instructing another device to perform the automated action) based on classifying the new observation in the first cluster, such as the first automated action described above.

As another example, if the ML system were to classify the new observation in a second cluster (e.g., second condition of the UE 120), then the ML system may provide a second (e.g., different) recommendation (e.g., set of codewords) or may perform or cause performance of a second (e.g., different) automated action, such as selection of a different set of codewords.

In some implementations, the recommendation or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, among other values), or may be based on a cluster in which the new observation is classified.

In some implementations, the trained ML model 625 may be re-trained using feedback information. For example, feedback may be provided to the ML model. The feedback may be associated with actions performed based on the recommendations provided by the trained ML model 625 or automated actions performed, or caused, by the trained ML model 625. In other words, the recommendations or actions output by the trained ML model 625 may be used as inputs to re-train the ML model (e.g., a feedback loop may be used to train or update the ML model). For example, the feedback information may include observed accuracies for sets of codewords.

In this way, the ML system may apply a rigorous and automated process to RSRP measurement compression. The ML system enables recognition or identification of tens, hundreds, thousands, or millions of features or feature values for tens, hundreds, thousands, or millions of observations, thereby increasing accuracy and consistency and reducing delay associated with codeword selection relative to requiring computing resources to be allocated for tens, hundreds, or thousands of operators to manually measure and select codewords using the features or feature values. These training processes may also be applied to ML models for RSRP measurement decompression or reconstruction.

As indicated above, FIG. 6 is provided as an example. Other examples may differ from what is described with regard to FIG. 6.

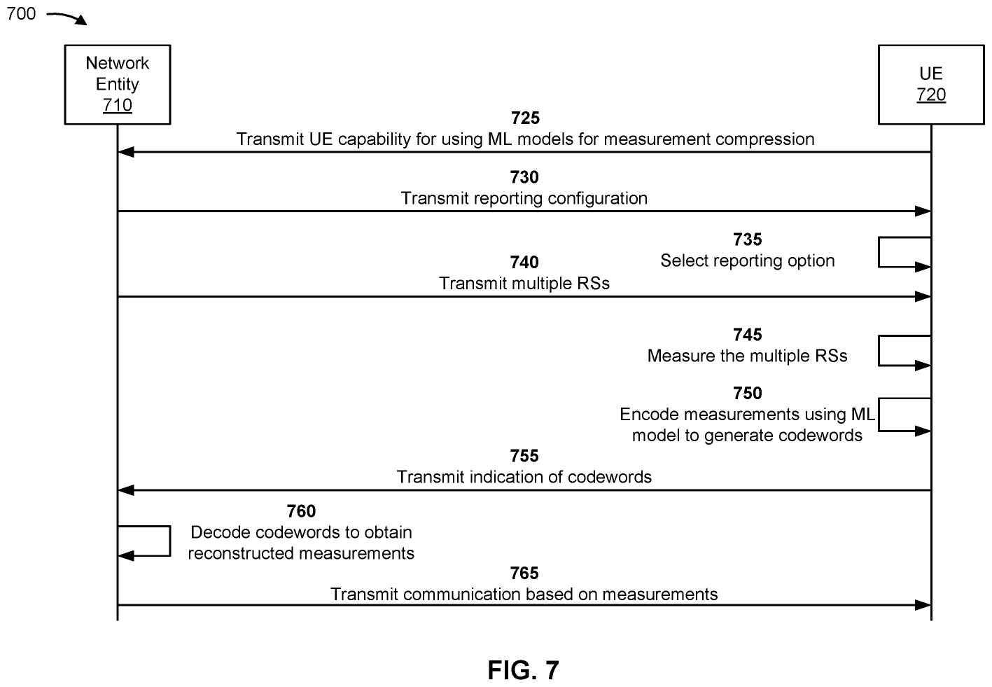

FIG. 7 is a diagram illustrating an example 700 associated with RSRP measurement compression, in accordance with the present disclosure. As shown in example 700 in FIG. 7, a network entity 710 (e.g., a network node 110) and a UE 720 (e.g., UE 120) may communicate with one another via a wireless network (e.g., wireless network 100).

Example 700 shows a process for compressing and decompressing measurements for multiple RSs that are provided in a single report. The network entity 710 may configure the UE 720 to use ML for the compressing. In association with such configurations, the UE 720 may transmit an indication of a UE capability for using ML models for compressing measurements of multiple RSs, as shown by reference number 725. As shown by reference number 730, the network entity 710 may transmit a reporting configuration. The reporting configuration may include information about an ML model that the UE is to use for the compressing. The information may also include a compression ML model architecture, a vector quantization architecture, an encoder architecture, and/or parameters of an ML model for compression. The reporting configuration may be based at least in part on the UE capability provided by the UE 720. The reporting configuration may be transmitted via RRC signaling or a MAC CE. As shown by reference number 735, the UE 720 may select a reporting option if the reporting configuration provided multiple reporting options. This may also take place later, such as after measuring the multiple RSs.

As shown by reference number 740, the network entity 710 may transmit multiple RSs, such as a set of multiple SSBs or a set of multiple CSI-RSs. As shown by reference number 745, the UE 720 may measure the multiple RSs to generate multiple measurements (e.g., RSRP measurements) for the multiple RSs. There may be measurements for more than 4 RSs, such as for over a hundred RSs.

As shown by reference number 750, the UE 720 may encode the measurements using an ML model to generate codewords representing a quantized version of the measurements. This may include quantizing the measurements into values (e.g., floating point, fixed point) for a specified quantity of sub-vectors and mapping the values to a set of codewords. The codewords may be of a specified quantity. The mapping may involve selecting the closest codewords for the values. The ML model may be used to quantize the measurements and/or map quantized values to codewords. As shown by reference number 755, the UE 720 may transmit an indication of the codewords. The UE 720 may also transmit information about a selected ML model or a selected reporting configuration. In some aspects, the measurements may be differential measurements.

As shown by reference number 760, the network entity 710 may decode the codewords to obtain reconstructed measurements for the multiple RSs. The network entity 710 may map codewords to quantized values for the multiple RSs, using a codebook shared with the UE 720. The network entity 710 may use an ML model for decompression to decode the codewords and/or to reconstruct the measurements for the multiple RSs. The multiple RSs may be in a predefined order or indexed in a way that the network entity 710 may associate measurements with RSs without the transmission of information for identifying the multiple RSs. The network entity 710 may use the measurements for beam management, adjusting communications, scheduling communications, transmitting RS s, generating a configuration, and/or estimating a channel. As shown by reference number 765, the network entity 710 transmit a communication, which may be data, control information, an RS, a configuration, or some other type of information that is based on the use of the measurements. The network entity 710 may also use the decompressed (reconstructed) measurements as data for training ML models. By training and using ML models for the compression and decompression of measurements for multiple RSs, the network entity 710 and the UE 720 may conserve signaling resources by using fewer bits for measurements for multiple RSs.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120, UE 720) performs operations associated with compressing measurements for multiple RSs.

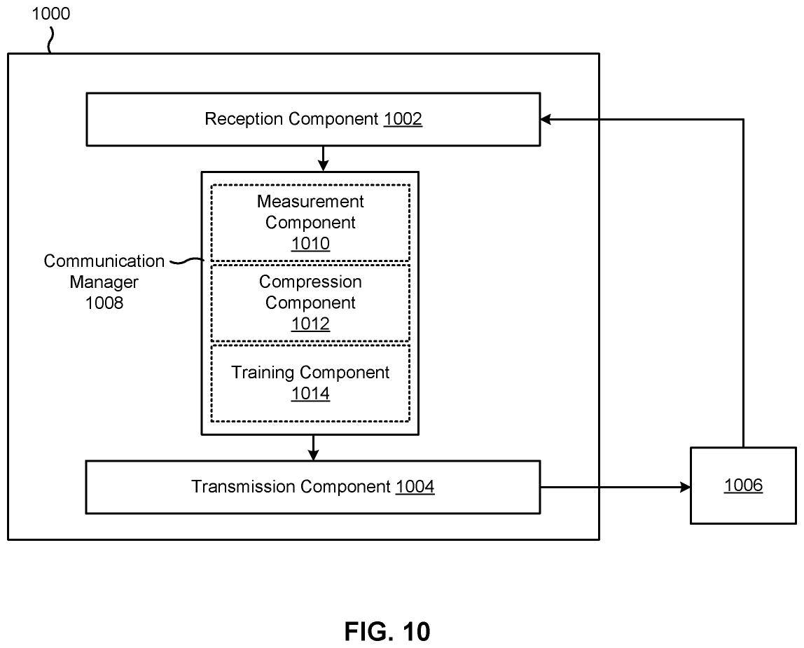

As shown in FIG. 8, in some aspects, process 800 may include receiving multiple RSs (block 810). For example, the UE (e.g., using communication manager 1008 and/or reception component 1002 depicted in FIG. 10) may receive multiple RSs, as described above.

As further shown in FIG. 8, in some aspects, process 800 may include measuring the multiple RSs to generate measurements for the multiple RSs (block 820). For example, the UE (e.g., using communication manager 1008 and/or measurement component 1010 depicted in FIG. 10) may measure the multiple RSs to generate measurements for the multiple RSs, as described above.

As further shown in FIG. 8, in some aspects, process 800 may include encoding the measurements using an ML model to generate codewords representing a quantized version of the measurements (block 830). For example, the UE (e.g., using communication manager 1008 and/or compression component 1012 depicted in FIG. 10) may encode the measurements using an ML model to generate codewords representing a quantized version of the measurements, as described above.

As further shown in FIG. 8, in some aspects, process 800 may include transmitting the codewords (block 840). For example, the UE (e.g., using communication manager 1008 and/or transmission component 1004 depicted in FIG. 10) may transmit the codewords, as described above.

Process 800 may include additional aspects, such as any single aspect or any combination of aspects described below and/or in connection with one or more other processes described elsewhere herein.

In a first aspect, the multiple RSs are CSI-RSs or SSBs.

In a second aspect, alone or in combination with the first aspect, the measurements are L1 RSRP measurements.

In a third aspect, alone or in combination with one or more of the first and second aspects, encoding the measurements includes encoding differential measurements that are each a difference between a respective measurement of the measurements and a strongest measurement of the measurements, and transmitting the codewords includes transmitting the codewords with an indication of the strongest measurement.

In a fourth aspect, alone or in combination with one or more of the first through third aspects, a quantity of the multiple RSs is greater than 4 RSs.

In a fifth aspect, alone or in combination with one or more of the first through fourth aspects, process 800 includes training the ML model using RS measurements as inputs and quantized versions of the RS measurements as outputs.

In a sixth aspect, alone or in combination with one or more of the first through fifth aspects, process 800 includes transmitting one or more of an indication of an architecture of the ML model or parameters of the ML model.

In a seventh aspect, alone or in combination with one or more of the first through sixth aspects, training the ML model includes training ML models of different types or for different quantities of RSs.

In an eighth aspect, alone or in combination with one or more of the first through seventh aspects, process 800 includes receiving, in a reporting configuration, one or more of an indication of an architecture of the ML model or parameters of the ML model, where encoding the measurements includes encoding the measurements using the architecture or the parameters.

In a ninth aspect, alone or in combination with one or more of the first through eighth aspects, process 800 includes receiving a reporting configuration that indicates a reporting option from among multiple reporting options, where encoding the measurements includes encoding the measurements based at least in part on the reporting option.

In a tenth aspect, alone or in combination with one or more of the first through ninth aspects, process 800 includes receiving a reporting configuration that indicates multiple reporting options, where encoding the measurements includes selecting a reporting option from among the multiple reporting options and encoding the measurements based at least in part on the selected reporting option.

In an eleventh aspect, alone or in combination with one or more of the first through tenth aspects, process 800 includes transmitting an indication of the selected reporting option.

In a twelfth aspect, alone or in combination with one or more of the first through eleventh aspects, selecting the reporting option includes selecting the reporting option based at least in part on one or more of an accuracy of the quantized version of the measurements or a payload size of the quantized version of the measurements.

In a thirteenth aspect, alone or in combination with one or more of the first through twelfth aspects, selecting the reporting option includes selecting the reporting option based at least in part on information in the reporting configuration or a rule in the reporting configuration.

In a fourteenth aspect, alone or in combination with one or more of the first through thirteenth aspects, process 800 includes transmitting an indication of a UE capability for using ML to generate codewords representing a quantized version of RS measurements.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network node 110, network entity 710) performs operations associated with decompressing codewords to reconstruct measurements for multiple RSs.

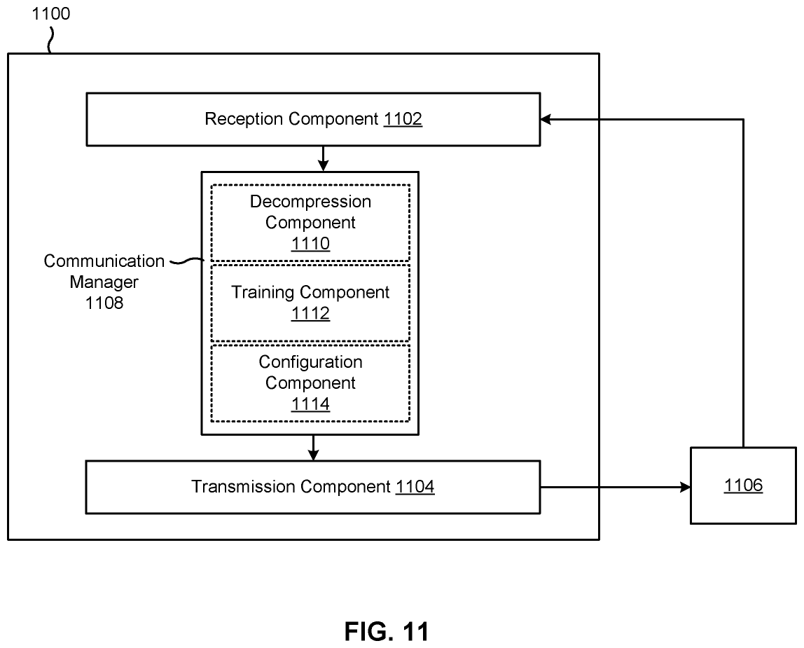

As shown in FIG. 9, in some aspects, process 900 may include transmitting a reporting configuration associated with using ML for quantizing measurements of multiple RSs (block 910). For example, the network entity (e.g., using communication manager 1108 and/or transmission component 1104 depicted in FIG. 11) may transmit a reporting configuration associated with using ML for quantizing measurements of multiple RSs, as described above.

As further shown in FIG. 9, in some aspects, process 900 may include transmitting multiple RSs (block 920). For example, the network entity (e.g., using communication manager 1108 and/or transmission component 1104 depicted in FIG. 11) may transmit multiple RSs, as described above.

As further shown in FIG. 9, in some aspects, process 900 may include receiving codewords that represent a quantized version of measurements of the multiple RSs (block 930). For example, the network entity (e.g., using communication manager 1108 and/or reception component 1102 depicted in FIG. 11) may receive codewords that represent a quantized version of measurements of the multiple RSs, as described above.

As further shown in FIG. 9, in some aspects, process 900 may include decoding the codewords to obtain the measurements of the multiple RSs (block 940). For example, the network entity (e.g., using communication manager 1108 and/or decompression component 1110 depicted in FIG. 11) may decode the codewords to obtain the measurements of the multiple RSs, as described above.

Process 900 may include additional aspects, such as any single aspect or any combination of aspects described below and/or in connection with one or more other processes described elsewhere herein.

In a first aspect, the quantized version of the measurements is a quantized version of differential measurements that are each a difference between a respective measurement of the measurements and a strongest measurement of the measurements, receiving the codewords includes receiving an indication of the strongest measurement, and decoding the codewords includes adding the strongest measurement to each of the differential measurements to obtain the measurements of the multiple RSs.

In a second aspect, alone or in combination with the first aspect, process 900 includes training an ML model using compressed or quantized RS measurements as inputs and reconstructed RS measurements as outputs.

In a third aspect, alone or in combination with one or more of the first and second aspects, process 900 includes transmitting one or more of an indication of an architecture of the ML model or parameters of the ML model.

In a fourth aspect, alone or in combination with one or more of the first through third aspects, training the ML model includes training ML models of different types or for different quantities of RSs.

In a fifth aspect, alone or in combination with one or more of the first through fourth aspects, process 900 includes receiving one or more of an indication of an architecture of an ML model or parameters of the ML model, where decoding the codewords includes decoding the codewords using the architecture or the parameters.

In a sixth aspect, alone or in combination with one or more of the first through fifth aspects, the reporting configuration indicates a reporting option from among multiple reporting options.

In a seventh aspect, alone or in combination with one or more of the first through sixth aspects, the reporting configuration indicates multiple reporting options.

In an eighth aspect, alone or in combination with one or more of the first through seventh aspects, the reporting configuration includes information or a rule for selecting a reporting option from among the multiple reporting options.

In a ninth aspect, alone or in combination with one or more of the first through eighth aspects, process 900 includes receiving an indication of a UE capability for using ML to generate codewords representing a quantized version of RS measurements and generating the reporting configuration based at least in part on the UE capability.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., UE 120, UE 720), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the UE described in connection with FIG. 2. The communication manager 1008 may be, or be similar to, the communication manager 140 depicted in FIGS. 1 and 2. For example, in some aspects, the communication manager 1008 may be configured to perform one or more of the functions described as being performed by the communication manager 140. In some aspects, the communication manager 1008 may include the reception component 1002 and/or the transmission component 1004. The communication manager 1008 may include one or more of a measurement component 1010, a compression component 1012, and/or a training component 1014, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive multiple RSs. The measurement component 1010 may measure the multiple RSs to generate measurements for the multiple RSs. The compression component 1012 may encode the measurements using an ML model to generate codewords representing a quantized version of the measurements. The transmission component 1004 may transmit the codewords.

The training component 1014 may train the ML model using RS measurements as inputs and quantized versions of the RS measurements as outputs. The transmission component 1004 may transmit one or more of an indication of an architecture of the ML model or parameters of the ML model.

The reception component 1002 may receive, in a reporting configuration, one or more of an indication of an architecture of the ML model or parameters of the ML model, and the compression component 1012 may encode the measurements using the architecture or the parameters. The reception component 1002 may receive a reporting configuration that indicates a reporting option from among multiple reporting options, and the compression component 1012 may encode the measurements based at least in part on the reporting option. The reception component 1002 may receive a reporting configuration that indicates multiple reporting options, and the compression component 1012 may select a reporting option from among the multiple reporting options. The compression component 1012 may encode the measurements based at least in part on the selected reporting option. The transmission component 1004 may transmit an indication of the selected reporting option.

The transmission component 1004 may transmit an indication of a UE capability for using ML to generate codewords representing a quantized version of RS measurements.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., network node 110, network entity 710), or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the network entity described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 150. In some aspects, the communication manager 1108 may include the reception component 1102 and/or the transmission component 1104. The communication manager 1108 may include one or more of a decompression component 1110, a training component 1112, and/or a configuration component 1114, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit a reporting configuration associated with using ML for quantizing measurements of multiple RSs. The transmission component 1104 may transmit multiple RSs. The reception component 1102 may receive codewords that represent a quantized version of measurements of the multiple RSs. The decompression component 1110 may decode the codewords to obtain the measurements of the multiple RSs.

The training component 1112 may train an ML model using compressed or quantized RS measurements as inputs and reconstructed RS measurements as outputs. The transmission component 1104 may transmit one or more of an indication of an architecture of the ML model or parameters of the ML model. The reception component 1102 may receive one or more of an indication of an architecture of an ML model or parameters of the ML model, and the decompression component 1110 may decode the codewords using the architecture or the parameters.

The reception component 1102 may receive an indication of a UE capability for using ML to generate codewords representing a quantized version of RS measurements. The configuration component 1114 may generate the reporting configuration based at least in part on the UE capability.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an apparatus of a user equipment (UE), comprising: receiving multiple reference signals (RSs); measuring the multiple RSs to generate measurements for the multiple RSs; encoding the measurements using a machine learning model to generate codewords representing a quantized version of the measurements; and transmitting the codewords.

Aspect 2: The method of Aspect 1, wherein the multiple RSs are channel state information RSs or synchronization signal blocks.

Aspect 3: The method of Aspect 1 or 2, wherein the measurements are Layer 1 reference signal received power measurements.

Aspect 4: The method of any of Aspects 1-3, wherein encoding the measurements includes encoding differential measurements that are each a difference between a respective measurement of the measurements and a strongest measurement of the measurements, and wherein transmitting the codewords includes transmitting the codewords with an indication of the strongest measurement.

Aspect 5: The method of any of Aspects 1-4, wherein a quantity of the multiple RSs is greater than 4 RSs.

Aspect 6: The method of any of Aspects 1-5, further comprising training the machine learning model using RS measurements as inputs and quantized versions of the RS measurements as outputs.

Aspect 7: The method of Aspect 6, further comprising transmitting one or more of an indication of an architecture of the machine learning model or parameters of the machine learning model.

Aspect 8: The method of Aspect 6 or 7, wherein training the machine learning model includes training machine learning models of different types or for different quantities of RSs.

Aspect 9: The method of any of Aspects 1-8, further comprising receiving, in a reporting configuration, one or more of an indication of an architecture of the machine learning model or parameters of the machine learning model, wherein encoding the measurements includes encoding the measurements using the architecture or the parameters.

Aspect 10: The method of any of Aspects 1-9, further comprising receiving a reporting configuration that indicates a reporting option from among multiple reporting options, wherein encoding the measurements includes encoding the measurements based at least in part on the reporting option.

Aspect 11: The method of any of Aspects 1-10, further comprising receiving a reporting configuration that indicates multiple reporting options, wherein encoding the measurements includes selecting a reporting option from among the multiple reporting options and encoding the measurements based at least in part on the selected reporting option.

Aspect 12: The method of Aspect 11, further comprising transmitting an indication of the selected reporting option.

Aspect 13: The method of Aspect 11 or 12, wherein selecting the reporting option includes selecting the reporting option based at least in part on one or more of an accuracy of the quantized version of the measurements or a payload size of the quantized version of the measurements.

Aspect 14: The method of any of Aspects 11-13, wherein selecting the reporting option includes selecting the reporting option based at least in part on information in the reporting configuration or a rule in the reporting configuration.

Aspect 15: The method of any of Aspects 11-14, further comprising transmitting an indication of a UE capability for using machine learning to generate codewords representing a quantized version of RS measurements.

Aspect 16: A method of wireless communication performed by an apparatus of a network entity, comprising: transmitting a reporting configuration associated with using machine learning for quantizing measurements of multiple reference signals (RSs); transmitting multiple RSs; receiving codewords that represent a quantized version of measurements of the multiple RSs; and decoding the codewords to obtain the measurements of the multiple RSs.

Aspect 17: The method of Aspect 16, wherein the quantized version of the measurements is a quantized version of differential measurements that are each a difference between a respective measurement of the measurements and a strongest measurement of the measurements, wherein receiving the codewords includes receiving an indication of the strongest measurement, and wherein decoding the codewords includes adding the strongest measurement to each of the differential measurements to obtain the measurements of the multiple RSs.

Aspect 18: The method of Aspect 16 or 17, further comprising training a machine learning model using compressed or quantized RS measurements as inputs and reconstructed RS measurements as outputs.

Aspect 19: The method of Aspect 18, further comprising transmitting one or more of an indication of an architecture of the machine learning model or parameters of the machine learning model.

Aspect 20: The method of Aspect 18 or 19, wherein training the machine learning model includes training machine learning models of different types or for different quantities of RSs.

Aspect 21: The method of any of Aspect 16-20, further comprising receiving one or more of an indication of an architecture of a machine learning model or parameters of the machine learning model, wherein decoding the codewords includes decoding the codewords using the architecture or the parameters.

Aspect 22: The method of any of Aspect 16-21, wherein the reporting configuration indicates a reporting option from among multiple reporting options.

Aspect 23: The method of any of Aspect 16-22, wherein the reporting configuration indicates multiple reporting options.

Aspect 24: The method of Aspect 23, wherein the reporting configuration includes information or a rule for selecting a reporting option from among the multiple reporting options.

Aspect 25: The method of any of Aspect 16-24, further comprising: receiving an indication of a user equipment (UE) capability for using machine learning to generate codewords representing a quantized version of RS measurements; and generating the reporting configuration based at least in part on the UE capability.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. An apparatus of a user equipment (UE) for wireless communication, comprising:
one or more memories; and
one or more processors coupled to the one or more memories, the one or more processors individually or collectively configured to cause the UE to:
receive multiple reference signals (RSs);
measure the multiple RSs to generate measurements for the multiple RS s;
encode the measurements using a machine learning model to generate codewords representing a quantized version of the measurements; and
transmit the codewords.

2. The apparatus of claim 1, wherein the multiple RSs are channel state information RSs or synchronization signal blocks.

3. The apparatus of claim 1, wherein the measurements are Layer 1 reference signal received power measurements.

4. The apparatus of claim 1, wherein the one or more processors, to encode the measurements, are individually or collectively configured to cause the UE to encode differential measurements that are each a difference between a respective measurement of the measurements and a strongest measurement of the measurements, and wherein the one or more processors, to transmit the codewords, are individually or collectively configured to cause the UE to transmit the codewords with an indication of the strongest measurement.

5. The apparatus of claim 1, wherein a quantity of the multiple RSs is greater than 4 RSs.

6. The apparatus of claim 1, wherein the one or more processors are individually or collectively configured to cause the UE to train the machine learning model using RS measurements as inputs and quantized versions of the RS measurements as outputs.

7. The apparatus of claim 6, wherein the one or more processors are individually or collectively configured to cause the UE to transmit one or more of an indication of an architecture of the machine learning model or parameters of the machine learning model.

8. The apparatus of claim 6, wherein the one or more processors, to train the machine learning model, are individually or collectively configured to cause the UE to train machine learning models of different types or for different quantities of RSs.

9. The apparatus of claim 1, wherein the one or more processors are individually or collectively configured to cause the UE to receive, in a reporting configuration, one or more of an indication of an architecture of the machine learning model or parameters of the machine learning model, and wherein the one or more processors, to encode the measurements, are individually or collectively configured to cause the UE to encode the measurements using the architecture or the parameters.

10. The apparatus of claim 1, wherein the one or more processors are individually or collectively configured to cause the UE to receive a reporting configuration that indicates a reporting option from among multiple reporting options, and wherein the one or more processors, to encode the measurements, are individually or collectively configured to cause the UE to encode the measurements based at least in part on the reporting option.

11. The apparatus of claim 1, wherein the one or more processors are individually or collectively configured to cause the UE to receive a reporting configuration that indicates multiple reporting options, and wherein the one or more processors, to encode the measurements, are individually or collectively configured to cause the UE to select a reporting option from among the multiple reporting options and encode the measurements based at least in part on the selected reporting option.

12. The apparatus of claim 11, wherein the one or more processors are individually or collectively configured to cause the UE to transmit an indication of the selected reporting option.

13. The apparatus of claim 11, wherein the one or more processors, to select the reporting option, are individually or collectively configured to cause the UE to select the reporting option based at least in part on one or more of an accuracy of the quantized version of the measurements or a payload size of the quantized version of the measurements.

14. The apparatus of claim 11, wherein the one or more processors, to select the reporting option, are individually or collectively configured to cause the UE to select the reporting option based at least in part on information in the reporting configuration or a rule in the reporting configuration.

15. The apparatus of claim 1, wherein the one or more processors are individually or collectively configured to cause the UE to transmit an indication of a UE capability for using machine learning to generate codewords representing a quantized version of RS measurements.

16. An apparatus of a network entity for wireless communication, comprising:
one or more memories; and
one or more processors coupled to the one or more memories, the one or more processors configured to cause the network entity to:
transmit a reporting configuration associated with using machine learning for quantizing measurements of multiple reference signals (RSs);
transmit multiple RSs;
receive codewords that represent a quantized version of measurements of the multiple RSs; and
decode the codewords to obtain the measurements of the multiple RSs.

17. The apparatus of claim 16, wherein the quantized version of the measurements is a quantized version of differential measurements that are each a difference between a respective measurement of the measurements and a strongest measurement of the measurements, wherein the one or more processors, to receive the codewords, are individually or collectively configured to cause the network entity to receive an indication of the strongest measurement, and wherein the one or more processors, to decode the codewords, are individually or collectively configured to cause the network entity to add the strongest measurement to each of the differential measurements to obtain the measurements of the multiple RSs.

18. The apparatus of claim 16, wherein the one or more processors are individually or collectively configured to cause the network entity to train a machine learning model using compressed or quantized RS measurements as inputs and reconstructed RS measurements as outputs.

19. The apparatus of claim 18, wherein the one or more processors are individually or collectively configured to cause the network entity to transmit one or more of an indication of an architecture of the machine learning model or parameters of the machine learning model.

20. The apparatus of claim 18, wherein the one or more processors, to train the machine learning model, are individually or collectively configured to cause the network entity to train machine learning models of different types or for different quantities of RSs.

21. The apparatus of claim 16, wherein the one or more processors are individually or collectively configured to cause the network entity to receive one or more of an indication of an architecture of a machine learning model or parameters of the machine learning model, and wherein the one or more processors, to decode the codewords, are individually or collectively configured to cause the network entity to decode the codewords using the architecture or the parameters.

22. The apparatus of claim 16, wherein the reporting configuration indicates a reporting option from among multiple reporting options.

23. The apparatus of claim 16, wherein the reporting configuration indicates multiple reporting options.

24. The apparatus of claim 23, wherein the reporting configuration includes information or a rule for selecting a reporting option from among the multiple reporting options.

25. The apparatus of claim 16, wherein the one or more processors are individually or collectively configured to cause the network entity to:
receive an indication of a user equipment (UE) capability for using machine learning to generate codewords representing a quantized version of RS measurements; and
generate the reporting configuration based at least in part on the UE capability.

26. A method of wireless communication performed by an apparatus of a user equipment (UE), comprising:
receiving multiple reference signals (RSs);
measuring the multiple RSs to generate measurements for the multiple RS s;
encoding the measurements using a machine learning model to generate codewords representing a quantized version of the measurements; and
transmitting the codewords.

27. The method of claim 26, wherein encoding the measurements includes encoding differential measurements that are each a difference between a respective measurement of the measurements and a strongest measurement of the measurements, and wherein transmitting the codewords includes transmitting the codewords with an indication of the strongest measurement.

28. The method of claim 26, further comprising receiving, in a reporting configuration, one or more of an indication of an architecture of the machine learning model or parameters of the machine learning model, wherein encoding the measurements includes encoding the measurements using the architecture or the parameters.

29. A method of wireless communication performed by an apparatus of a network entity, comprising:
transmitting a reporting configuration associated with using machine learning for quantizing measurements of multiple reference signals (RSs);
transmitting multiple RSs;
receiving codewords that represent a quantized version of measurements of the multiple RSs; and
decoding the codewords to obtain the measurements of the multiple RSs.

30. The method of claim 29, further comprising:
receiving an indication of a user equipment (UE) capability for using machine learning to generate codewords representing a quantized version of RS measurements; and
generating the reporting configuration based at least in part on the UE capability.
